(19) United States
(12) Patent Application Publication
(10) Pub. No.: US 2021/0169090 A1
(43) Pub. Date: Jun. 10, 2021

(54) COMPOSITIONS OF HYDROLYZED LECITHIN AND LECITHIN FOR TORTILLAS AND RELATED METHODS

(71) Applicant: KEMIN INDUSTRIES, INC., Des Moines, IA (US)

(72) Inventors: Lan BAN, West Des Moines, IA (US); Chia-Yu SHEN, Ames, IA (US); Joan RANDALL, Ames, IA (US); William D. SCHROEDER, Ames, IA (US)

(21) Appl. No.: 17/117,086

(22) Filed: Dec. 9, 2020

Related U.S. Application Data
(60) Provisional application No. 62/945,628, filed on Dec. 9, 2019.

(51) Int. Cl. A21D 2/16; A21D 13/42

(52) U.S. Cl. CPC A21D 2/16; A21D 13/42

(57) ABSTRACT

The present invention offers a new composition for tortillas, and more specifically a composition comprising hydrolyzed lecithin and lecithin in an amount effective to confer superior properties to the tortillas, such as anti-stickiness, where the composition can be incorporated as an ingredient in the formulation of the tortillas. Other aspects of the present invention relate to methods of making and using the compositions of the present invention to prevent the peeling or tearing of tortillas when separated.

### CROSS-REFERENCE TO RELATED APPLICATIONS

This application claims the benefit of priority to United States Provisional Patent Application No. 62/945,628, filed Dec. 9, 2019, entitled “HYDROLYZED LECITHIN AND LECITHIN BLEND FOR TORTILLAS,” the entire disclosure of which is hereby incorporated by reference in its entirety.

### BACKGROUND

The present invention offers a new composition for tortillas, and more specifically a composition comprising a blend of hydrolyzed lecithin and lecithin that can be incorporated as an ingredient in the formulation of the tortillas or applied to finished tortillas in order to confer superior qualities to the tortilla. For instance, the present invention provides a desirable anti-tackiness or anti-stickiness quality to the finished tortilla. This is a particularly beneficial attribute for extending the shelf-life of tortillas, including but not limited to tortillas that are stored at room temperature, as well as tortillas that are refrigerated or frozen.

As background, the tortilla is the traditional unleavened flat bread that originated from the Central American regions. Tortillas can be made from either corn or wheat. Tortillas have gained popularity in North America and with increased demand have become a staple food in the United States. Today, this market accounts for over $6 billion annually, and is anticipated to surpass demand for traditional, yeast leavened bread.

With respect to wheat tortillas, desirable characteristics include but are not limited to round and symmetric appearance, puffy and soft texture, with a shelf life (both texture and microbial stability) between 7 days to 45 days. In addition, after the tortillas are made, 10-20 pieces are stacked in the packaging material. The packs could be also stacked during storage and in the retail setting. Moisture migration to surface, fat type and content, and surface properties (such as surface activity and roughness) of tortilla all contribute to tortilla sticking to each other. On the other hand, processing and cooking conditions will also impact finished tortilla stickiness. The stickiness characteristic has been long-recognized as a challenge for the tortilla industry, where sticky tortillas result in lower consumer acceptance when the consumer experience includes torn tortillas caused by stickiness on the surface of a tortilla and damage when a consumer attempts to peel a tortilla from the stack.

Presently, it has been accepted in the industry that low iodine value mono- & di-glycerides (MDG) could mitigate the stickiness problem, and thus, it is widely used in applications for wheat tortillas. In addition, other types of ingredients were also tested with various success levels, such as the addition of glycerol and gums. Jigarbhai H. Rathod, Master of Science Thesis, Rutgers, The State University of New Jersey, 2008. Their functions are mostly to reduce water activity level of tortilla, which reduce the free water available for migration.

It is also generally understood that the term “MDG” could refer to different molecules, where the molecules all share the same head group which is a glycerol as they are made by partial hydrolysis of triglyceride. One or two of the hydroxy groups of the glycerol is linked through an ester bond to fatty acid carbon chains. For the MDG that are most common in tortilla industry, the original triglyceride source is either palm or trans-esterified, which are highly saturated. For instance, Corbion's MDG, TRANCENDIM 180 (T180), is one of the most recognized MDGs for its good anti-stickiness properties.

The mechanism of MDG to prevent stickiness was proposed as reducing the surface activity of tortilla, which was illustrated by larger contact angles when a drop of water was added to the surface. It was also shown that T180 treated tortilla resulted in smoother surface. T180 MDG contains 66% diglyceride, 27.9% triglycerides and 6% monoglycerides (supplier specifications), making it a very nonpolar emulsifier. The high amount of diglyceride might render it to influence the surface property (lower surface tension) and interact with the fat phase well to limit the mobility of free water.

One drawback to this approach is that MDGs are considered to be synthetic. Thus, in view of increased consumer demand, replacing MDGs with a clean label alternative is viewed as particularly desirable. Lecithin has been identified previously as a possible substitute and began to dominate the clean label tortilla market as a clean label emulsifier. See U.S. Pat. No. 9,549,561 B2 and U.S. Application No. 2013/0243916 A1, incorporated in their entirety by reference. The major molecules in lecithin include a group of phospholipids that were produced as a byproduct from vegetable oil manufacturing. Popular sources are soy, canola/rapeseed and sunflower. Lecithin could be further hydrolyzed into a new group of phospholipids that are called lysolecithin. While MDGs and lecithin won't dissolve or mix well in water, lysolecithin could form stable mixture in water. Lysolecithin has shown to have better emulsification capabilities in oil-in-water emulsions and have found many applications, including for instance cosmetic products and animal nutrition. See U.S. Pat. No. 9,173,419B2, incorporated by reference in its entirety.

In the food industry, lysolecithin, or hydrolyzed lecithin, is commercially available and as compared to lecithin, known to increase emulsification capabilities in the oil-in-water emulsions. Anna-Maria Aura, Pirkko Forssell, Annikka Mustranta, Tapani Suortti and Kaisa Poutanen. Enzymatic Hydrolysis of Oat and Soya Lecithin: Effects on Functional Properties. Journal of American Oil Chemists' Society, Vol. 71, 887-891 (1994).

There are also limited additional applications describing the use of lysolecithin as an emulsifier in delivering edible ink, an emulsifier in making cakes, an emulsifier in a flavored beverage, and lysolecithin was generated in a grain byproduct by the use of phospholipids and used as an emulsifier when the byproduct is incorporated in baked goods. See U.S. Patent App. No. 2008/0075830A1, U.S. Patent App. No. 2015/0313243A1, U.S. Patent App. No. 2017/0311632 A1, and U.S. Pat. No. 9,370,193, respectively. None of the prior disclosures, however, have attempted to use a blend of hydrolyzed lecithin and lecithin to address the problems solved by the present invention.

### BRIEF SUMMARY OF INVENTION

The present invention offers a new composition for tortillas, and more specifically a composition comprising a blend of hydrolyzed lecithin and lecithin that can be incorporated as either a dry or wet ingredient in the formulation of the tortillas. In certain embodiments, the composition is incorporated into the tortilla dry blend. In alternative embodiments, the composition is incorporated into the fat source in the tortilla. In another embodiment, the composition could be applied to finished tortillas. The composition imparts desirable properties to the finished tortillas, for instance, providing an anti-tackiness or anti-stickiness quality to the finished tortilla. This is a particularly beneficial attribute for extending the shelf-life of tortillas, including but not limited to tortillas that are stored at room temperature, as well as tortillas that are refrigerated or frozen.

These and other aspects, objects, and features of the present disclosure will be understood and appreciated by those skilled in the art upon studying the following specification, claims, and appended drawings.

### BRIEF DESCRIPTION OF THE FIGURES

In the drawings:

FIG. 1 depicts the tortillas, specifically the left photograph provides an example of a loose tortilla; the middle photograph depicts a tortilla that was zippering and starting to stick after 4 weeks of storage at ambient condition (22-24° C., relative humidity=60-75%); the right photograph depicts a tortilla that was torn after 4 weeks of storage under the same condition as in the middle, where the tortilla on the right did not contain MDG's or ingredients to prevent stickiness.

FIG. 2 depicts the contact angle definition.

FIG. 3 shows the contact angle results for the study.

FIG. 4 depicts possible scenario as to how lysolecithin works to prevent water from migration to the surface.

FIG. 5 is a photograph of a loose tortilla, where the tortilla is easily separated without evidence of zippering sound or any sticking to other tortillas.

FIG. 6 depicts zippering of tortillas, where zippering sound is present but the tortillas do not stick together or peel.

FIG. 7 depicts peeling of tortillas, where the tortillas surface stick to each other without tearing through to the other side of the tortilla.

FIG. 8 depicts tearing of tortillas, where the tortillas tear through to other side.

FIG. 9 depicts Day 28 load test results for clean label tortillas. Error bars are standard deviation of reps. N=2. Lyso=lysolecithin.

FIG. 10 depicts Day 52 load test results for clean label tortillas. Error bars are standard deviation of reps. N=2. Lyso=lysolecithin.

### DETAILED DESCRIPTION OF THE INVENTION

For purposes of description herein, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

### Example 1—Typical Food Service Style Tortillas

Materials and reagents. The major ingredients in flour tortilla include water, flour and fat. There are minor ingredients in flour tortilla that are less in concentrations but essential for delivering a tortilla with good quality. Those minor ingredients would improve the flavor (salt and sugar), softness (enzymes and hydrocolloids), microbial stability (antimicrobial reagents and acidulants), anti-stickiness (mono & diglycerides or MDGs) and staling (distilled monoglycerides and enzymes). Kemin Food Technologies has previously commercialized batch pack solutions to provide a blend that incorporates all the minor ingredient into one pack for easy handling. Table 1 summarizes the ingredients that are used to manufacture a representative batch pack product, TillaPack™ FSS 1913. The shortening for tortilla is a palm-based and made from AAK. Lot #070219N5 was used in this study.

TABLE 1
Formula of TillaPack ™ FSS 1913

| RM # | Supplier | Ingredients | (wt %) |
|---|---|---|---|
| RM16955 | Cargill | Salt | 23.38% |
| RM60001 | Niacet | Calcium Propionate, Crystal | 15.49% |
| RM60018 | United Sugars | Sugar | 6.29% |
| RM80753 | Riceland/AV Gums | Rice Flour, Regular | 9.09% |
| RM60022 | Royal Ingredients | Gluten | 3.50% |
| RM60008 | Danisco | Tortilla Softener 2565 | 3.50% |
| RM60006 | AB Mauri | Inactive Dry Yeast | 0.10% |
| RM60011 | Innophos | Mono Calcium Phosphate, Monohydrate | 0.10% |
| RM60017 | Esseco | Sodium Metabisulfite | 0.09% |
| RM60005 | AV Gums | Guar Gum, 200# | 2.10% |
| RM02017 | ADM | Corn Starch | 2.50% |
| RM60010 | Innophos | Sodium Acid Pyro Phosphate | 3.00% |
| RM60014 | Vitusa (C&D) | Sodium Bicarbonate #1 | 2.80% |
| RM01308 | Nantong | Potassium Sorbate, granular | 5.59% |
| RM60004 | Tate and Lyle | Fumaric Acid, regular | 6.99% |
| RM60019 | Corbion | Mono-and Diglycerides T180 | 15.5% |
| | TOTAL | | 100.00% |

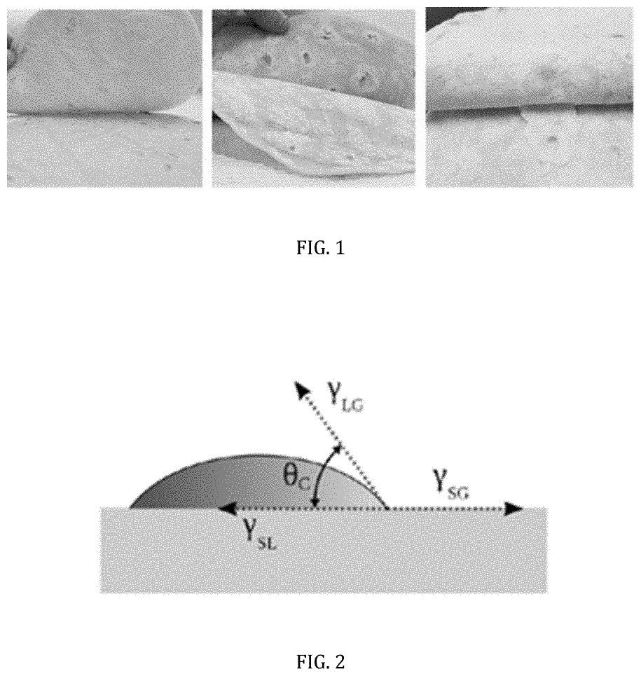

Hydrolyzed lecithin and lecithin as anti-stickiness reagent. It has been generally understood that mono & diglycerides (MDGs) have multiple functions in flat bread. One of them is the anti-sticking properties. Tortillas were manufactured and stacked for storage purpose, either in a grocery store or in manufacturers' warehouse. When a tortilla is served, it is desirable that each piece could be easily separated from the stack and there is no sign of tearing or “zippering”, a phenomenon that a tortilla is stuck in the stack and would require extra force to detach from the stack. FIG. 1 shows various tortilla samples that are torn due to the stickiness in a stack during storage.

In this experiment, hydrolyzed sunflower lecithin (RM80775, from Sime Darby) and sunflower lecithin (RM16492, from Austrade Inc.) were tested. The total phospholipids contents, measured by acetone insolubles, are around 56% for RM80775 and 60% for RM16492 (from suppliers' specifications sheets). RM 80775 is partially hydrolyzed. The supplier also shared typical breaking down of the phospholipids in the product and it was calculated that only 10.64% (by mols) of the total phospholipids were hydrolyzed. Undigested phospholipids are still the major portion of the phospholipids but much higher amount of lysolecithin was produced comparing to conventional sunflower lecithin.

Manufacturing of burrito style tortilla. A burrito-style tortilla were manufactured using a commercial tortilla oven that contain wheat flour, shortening, water and TillaPack FSS 1913. The recipe is shown in Table 2. For the evaluation of lysolecithin and lecithin, the two raw materials were blended at different ratios to observe which ratio would give the best performance. The total dosage of the sum of the two has been kept at 0.5% (wt) based on flour weight. As a reference, the positive control, T180, was dosed at 1.0% (wt) based on flour weight. Lysolecithin and lecithin were blended first in a beaker by hand, and plated on wheat flour at 1:10 wt:wt=total lecithin:wheat flour in a coffee grinder for 1 min at high setting. The resulted flour was incorporated into the batch pack formula of TillaPack FSS 1913 except for that T180 is taken out and replaced with the lysolecithin/lecithin blend. The treatment is summarized in Table 3.

The preliminary study has shown that at higher dosage at 1%, sunflower lecithin and lysolecithin would affect the appearance of this type of tortilla. In a different preliminary study, the researchers tested the mixing of lecithin/lysolecithin directly into shortening. The results demonstrated that the introduction of lysolecithin/lecithin could be either through dry batch pack or through shortening (fat) that is pre-treated.

TABLE 2
Recipe of a typical Burrito style tortilla that
is used to test the emulsifiers in this study

| Item | Weight (lbs) |
|---|---|
| Wheat flour | 2.86 |
| Palm shortening | 0.34 |
| Batch pack | 0.22 |
| Tap water | 1.58 |

TABLE 3
Treatment in this study.

| Total Dose (based | Treatment (ratio is |
|---|---|
| on flour weight) | based on weight) |
| 0 | Untreated |
| 1% | Corbion T180 |
| 0.50% | Lec/Lyso = 100/0 |
| 0.50% | Lec/Lyso = 75/25 |
| 0.50% | Lec/Lyso = 50/50 |
| 0.50% | Lec/Lyso = 25/75 |
| 0.50% | Lec/Lyso = 0/100 |

Lec = sunflower lecithin;
Lyso = sunflower lysolecithin

The first step of making tortilla is a blending step to incorporate all ingredients into a dough. This step was done in a Hobart blender (HL600-3STD). Briefly, the wheat flour was mixed with TillaPack FSS 1913 (or lysolecithin alternative) for 1 min at setting 2. Next, shortening was introduced to the blender and the mixture was blended for 2 min at setting 2. Tap water (temperature not controlled) was added next to the blender and the mixture was blended for 2 min at setting 1. The mixture was blended for additional 5 min at setting 2, at which point, a smooth flour dough was resulted. The dough was rested in the blender for additional 8 minutes.

The rested dough was retrieved from the blender and was divided into smaller pieces and rounded (one piece would result into one piece of tortilla) in a dough divider and rounder (Vendor—Duchess). The round dough was proofed in a proofer which was adjusted at 90° F. for 10 min.

The dough was fed into a three-tier tortilla oven (Superior, Food Machinery Incorporated, Pico Rivera, Calif.) that has in-line hot press following manufacturer's instruction. The oven temperature was set up to be as the following. Top tier—515° F.; Middle tier—465° F.; Lower tier—390° F.; Hot press top plate—400° F.; Lower plate—400° F.

Contact angle. Contact angle measures the surface tension by applying a droplet of water to be at the surface. The definition of contact angle is illustrated in FIG. 2 as θc. When contact angle is small as is the case in FIG. 2, the surface “likes” water, is wetted well by water, and it has high surface tension. In this study, 1 mL deionized water was gently dropped on the tortilla surface. A photo was taken and was analyzed for contact angle following the definition in FIG. 2. (retrieved from Chemistry LibreTexts website).

At least triplicated measurements were performed for each tortilla sample.

Anti-stickiness testing. A conventional “load test” method was adapted for this study. Ten pounds of weight (from stacked tortilla) were applied on top of a pack of tortilla of 10 pieces in a plastic bucket to simulate the pressure that would be applied to commercial tortilla. The bucket was stored at ambient condition (22-24° C., 60-75% relative humidity) for 4 weeks. At the end of the storage, the pack was retrieved, each piece was peeled from the stack slowly and the observations were recorded. If the tortilla was easy to be peeled, it was considered as “loose”; If there was a zippering sound that some minor force was applied to separate the tortilla, while no tearing happens, this tortilla was considered to create “zippering” which is the onset of sticking; if there was a scar during peeling, the tortilla was considered as “torn” which was the result of excessive stickiness (See, e.g. FIG. 1). Each tortilla was peeled while observation was recorded. The percentage of “loose”, “zippering” and “torn” tortilla out of the total tortilla pieces in the pack was calculated.

Other testing. Physical appearance, moisture content, texture are important parameters for the quality of tortilla. Those parameters were also evaluated for the tortilla made in this study following existing standard operating procedures.

Results

Physical parameters. The observational data on physical appearance of the tortilla are summarized in Table 4. The rolling score (testing flexibility of tortilla) and moisture content were summarized in Table 5. Tortilla treated with different lysolecithin/lecithin blend are not shown to be different in physical characteristics comparing to the positive control.

TABLE 4
The physical appearance of the tortilla.

| | | | Round | | | | | |
|---|---|---|---|---|---|---|---|---|
| | | | shape index | | % that are | | | |
| | | Diameter | (Round = | Thickness | not | % that are | | |
| Treatment | | (in) | 1.0) | (mm) | symmetric | symmetric | Crust Color | Translucency |
| Untreated | Avg | 9.39 | 1.09 | 4.24 | 80% | 20% | all light | Translucent |
| | STDEV | 0.57 | 0.04 | 0.17 | | | | |
| T180 | Avg | 9.48 | 1.09 | 4.57 | 80% | 20% | Light | Translucent |
| | STDEV | 0.47 | 0.02 | 0.3 | | | | |
| Lec/Lyso | Avg | 9.61 | 1.01 | 5.23 | 60% | 40% | Light-more | Uneven |
| 100/0= | STDEV | 0.28 | 0.1 | 0.77 | | | yellow than T180 | translucency |
| Lec/Lyso | Avg | 9.16 | 1.06 | 4.79 | 90% | 10% | Slightly darker/ | Translucent |
| 75/25= | STDEV | 0.51 | 0.06 | 0.37 | | | yellow than T180 | |
| Lec/Lyso | Avg | 8.86 | 1.04 | 4.52 | 50% | 50% | light | Translucent |
| 50/50= | STDEV | 0.27 | 0.04 | 0.67 | | | | |
| Lec/Lyso | Avg | 8.78 | 1.08 | 4.34 | 40% | 60% | light | Translucent |
| 25/75= | STDEV | 0.5 | 0.04 | 0.51 | | | | |
| Lec/Lyso | Avg | 9.09 | 1.04 | 4.16 | 50% | 50% | light | Translucent |
| 0/100= | STDEV | 0.25 | 0.02 | 0.32 | | | | |

Ave = average of three measurements;
STDEV = standard deviation

TABLE 5
Moisture content and rolling score of tortilla
which measures the flexibility of tortilla.

| | Moisture | Rolling score on |
|---|---|---|
| Treatment | % | flexibility (score 1 to 5) |
| Untreated | 26.55 | 5 |
| T180 | 28.76 | 5 |
| Lec/Lyso = 100/0 | 24.84 | 5 |
| Lec/Lyso = 75/25 | 27.03 | 5 |
| Lec/Lyso = 50/50 | 29.63 | 5 |
| Lec/Lyso = 25/75 | 28.75 | 5 |
| Lec/Lyso = 0/100 | 29.63 | 5 |

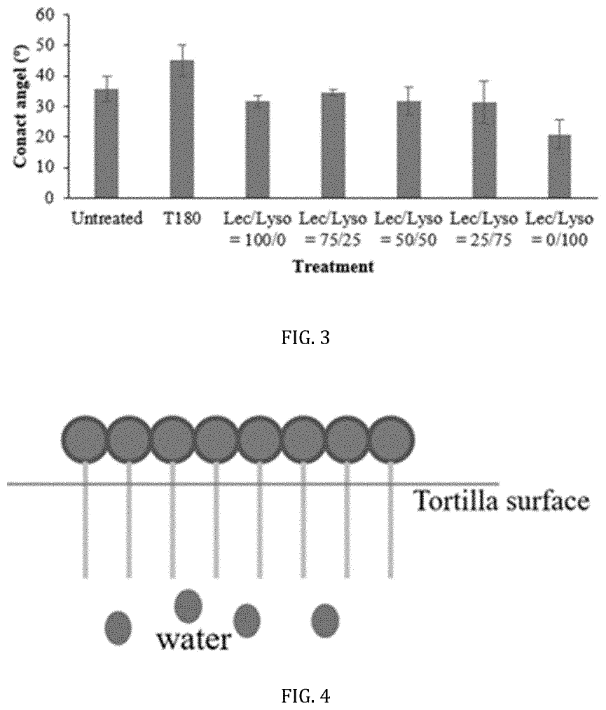

From the contact angle measurements (FIG. 3), it was confirmed that T180 treatment could increase the contact angle, which indicated lower surface energy. This was believed to be one of the key mechanisms for T180's function as anti-stickiness. None of the lysolecithin/lecithin groups were able to increase the contact angle comparing to negative control. Instead, when lysolecithin is used as 100% without adding sunflower lecithin, it had significantly lower contact angle, which indicated higher surface tension. This is expected as lysolecithin is more polar and has strong tendency to interact with water.

TABLE 6
Load test result on stickiness of the tortilla
after 4 weeks storage under pressure.

| Dose | | | | |
|---|---|---|---|---|
| (flour %) | Treatment | Loose % | Zip % | Torn % |
| 0 | Untreated | 0 | 89 | 11 |
| 1% | T180 | 11 | 67 | 22 |
| 0.50% | Lec/Lys = 100/0 | 0 | 0 | 100 |
| 0.50% | Lec/Lys = 75/25 | 0 | 22 | 78 |
| 0.50% | Lec/Lys = 50/50 | 0 | 0 | 100 |
| 0.50% | Lec/Lys = 25/75 | 44 | 55 | 0 |
| 0.50% | Lec/Lys = 0/100 | 56 | 44 | 0 |

The load test result is shown in Table 6. After 4 weeks storage under pressure, untreated tortilla was mostly stuck with each other and hard to peel, as reflected by the results that there was no loose tortilla. T180 has shown improvement over the untreated, although the spread was very wide. When there was higher amount of lecithin than lysolecithin, the tortilla was seriously stuck together and shown damaged surface.

However, higher amount of lysolecithin inclusion has significantly improved the stickiness of tortilla.

### DISCUSSION

In this study, the inventors were able to show that the contact angle of lysolecithin treated tortilla was significantly lower than the rest of the group. However, that alone didn't explain that lysolecithin at the same time provided great improvement on the tortilla stickiness problem. A mechanism was hypothesized by the researchers as described herein.

It is known that phospholipids could form layers (one scenario is shown in FIG. 4). Lysolecithin has phosphate head group which is very polar and non-polar carbon chain tail. If the headgroup is exposed at the surface of tortilla, the surface is likely to have higher affinity to water, which could explain the lower contact angle that was observed. By forming layers, there could be hydrophobic shield near the surface of tortilla that prevent water to migrate to the surface.

In conclusion, this preliminary study identified unexpected results, more specifically that lysolecithin has “anti-stickiness” characteristics and/or function and it is likely that new mechanism is involved. The researchers view these results as identifying a promising clean label alternative to existing anti-stickiness agents, such as MDGs or lecithin alone.

### Example 2—Clean-Label Tortilla System

Materials. The materials used in the preparation of the clean label batch pack are shown in Table 7.

TABLE 7
Raw materials used in the clean label batch pack for flour tortillas

| RM # | Ingredient | Manufacturer | Lot # |
|---|---|---|---|
| RM60001 | Calcium propionate | Niacet | 2001106356 |
| RM16955 | Sodium chloride | Cargill | 200410228 |
| RM60018 | Sugar | United Sugars | 1904109398 |
| RM60014 | Sodium bicarbonate #1 | Church and | 1905102766 |
| | | Dewight | |
| RM60022 | Citric acid-encapsulated | Watson | 1904111193 |
| | 85% | | |
| RM60022 | Vital wheat gluten | Royal | 19041111193 |
| | | Ingredients | |
| RM60020 | Ultrafresh 225 | Caravan | 1928100894 |
| | | Ingredients | |
| RM60005 | Guar gum | India Glycols | 1912113042 |
| | | Limited | |
| RM60024 | Sodium | CP Kelco | 1905111841 |
| | carboxymethylcellulose | | |
| RM60006 | Inactive yeast | AB Mauri | N8001M294HM |
| RM60039 | Bakezyme BXP 5001 BG | DSM | |
| RM60021 | Protease | AB Enzymes | 1912100775 |
| RM60030 | Mono-diglycerides | Fine Organics | 20021044491 |
| RM60029 | Distilled monoglycerides | Fine Organics | 211111981 |
| RM80775 | Sunflower lysolecithin | Sime Darby | 3814 |
| RM16492 | Sunflower lecithin | Giralec | 02419LG |
| RM02017 | Corn Starch | Archer Daniels | 2006100739 |
| | | Midland | |

The formulas used in the evaluation of the clean label batch pack are shown in Table 8. The values are shown in bakers' percent (based on the flour weight) which is commonly used in the bakery industry. Initial screening studies were used to determine the best ratio and replacement level for the lecithin/lysolecithin blend as well as the lecithin alone. For both the lecithin/lysolecithin blend and lecithin alone the most effective replacement level was 50% of the level of the positive control MDG. Corn starch was used as a filler for the negative control and both test samples to keep the total added ingredients constant.

TABLE 8
Tortilla formulas used in clean label evaluation (bakers %)

| | Negative | Positive | 25 Lecithin/ | |
|---|---|---|---|---|
| | control | control | 75 lysolecithin | Lecithin |
| Calcium propionate | 1.000 | 1.000 | 1.000 | 1.000 |
| Sodium chloride | 1.999 | 1.999 | 1.999 | 1.999 |
| Sugar | 1.907 | 1.907 | 1.907 | 1.907 |
| Sodium bicarbonate #1 | 0.500 | 0.500 | 0.500 | 0.500 |
| Citric acid-encapsulated | 0.810 | 0.810 | 0.810 | 0.810 |
| Vital wheat gluten | 0.248 | 0.248 | 0.248 | 0.248 |
| Ultrafresh 225 | 0.300 | 0.300 | 0.300 | 0.300 |
| Guar gum | 0.240 | 0.240 | 0.240 | 0.240 |
| Sodium | 0.080 | 0.080 | 0.080 | 0.080 |
| carboxymethylcellulose | | | | |
| Inactive yeast | 0.303 | 0.303 | 0.303 | 0.303 |
| Bakezyme BXP 5001 BG | 0.002 | 0.002 | 0.002 | 0.002 |
| Protease* | 0.004 | 0.004 | 0.004 | 0.004 |
| Mono-diglycerides | 0.000 | 0.930 | 0.000 | 0.000 |
| Distilled monoglycerides | 0.000 | 0.080 | 0.000 | 0.000 |
| Sunflower lysolecithin | 0.000 | 0.000 | 0.379 | 0.000 |
| Sunflower lecithin | 0.000 | 0.000 | 0.126 | 0.505 |
| Corn Starch | 1.010 | 0.000 | 0.505 | 0.505 |

Methods. Individual batch packs were prepared for each treatment and replicated (n=2). All dry ingredients were mixed together and packaged separately. As the MDG's in the positive control are dry they were blended with the other dry materials. Both the lecithin and lysolecithin are liquid products so as to facilitate better dispersion with the dry ingredients, were plated onto a small amount of wheat flour, which was subtracted from the total amount of flour used to prepare the tortillas.

The first column in Table 9 shows the percent of the formula based on flour, the remaining columns show the amount of flour (Gold Medal H&R All Purp Enrich Blch item number 5136460, Sysco), shortening (Soy Flex, Stratus Foods, item 106052BQ), batch pack and water (city water) used for each variable.

TABLE 9
Flour tortilla formula (lbs based on bakers’ (flour) percent).

| | | | | Lecithin/lysol | |
|---|---|---|---|---|---|
| | | Negative | Positive | ecithin | Lecithin- |
| | Flour % | control (lb) | control(lb) | blend(lb) | (lb) |
| Wheat flour | 100.00 | 25.00 | 25.00 | 23.79 | 23.79 |
| Soy/Cottonseed | 12.00 | 3.00 | 3.00 | 3.00 | 3.00 |
| blend shortening | | | | | |
| Batch pack | 8.40 | 2.10 | 2.10 | 2.10 | 2.10 |
| Water | 55.00 | 13.75 | 13.75 | 13.75 | 13.75 |

Methods for tortillas. Replicated batches (N=2) of tortillas were produced in house. Flour and batch pack were added to 60-quart Vollrath mixer (model MIX1060), the dough hook blade attached and mixed for 2 min on speed 1. Shortening was added and mixed for 2 min on speed 2. Water was added and mixed for 2 min on speed 2, then 6-8 min on speed 2. The dough was then divided into 4.2 lbs batches, covered with plastic wrap and allowed to proof at ambient temperature (75° F.) for 5-6 min. The dough was then flattened onto a rounder template and placed in the divided/rounder (Duchess model JN) and rounded for 20 seconds+/−5 seconds. After rounding the dough balls were placed on a 25×18 inch aluminum floured baking sheet, covered with plastic wrap and allowed to proof at ambient temperature for 10-11 min. After the proofing time the dough balls were processed through the tortilla oven (Superior Food Machinery, Pico Rivera, Calif.). Processing parameters are shown in Table 10.

TABLE 10
Processing parameters for GS tortillas. Average per tortilla batch

| Processing parameters | Range |
|---|---|
| Water (lbs) Temp 82-85° F. | 13.75 |
| Dough temp out of mixer (° F.) | 85-90 |
| # Dough balls | 360 |
| Temp of dough balls (° F.) | 82-85 |
| Dough ball weight (g) | 52-56 |
| Proofing temperature (° F.) | 75-82 |
| Tortilla temp at packaging (° F.) | 83-87 |
| Hot press temp - Upper/lower (° F.) | 360-385/348-387 |
| Tortillas produced | 360 |
| Size of tortillas (inches) | 87.5-8.0 |
| # Tortillas per bag | 10 |

Analyses. The tortillas were evaluated by subjective and objective tests to make sure the appearance, pH and initial texture were not affected by the treatments. The stickiness of the tortilla over time was evaluated by load test, the same method that was used in Example 1. The method is detailed below.

Load Test. The load test is used as a measure of stickiness. The load test is a standard test in the tortilla industry and is one of the key experiments in this study, which evaluated stickiness of the tortillas under pressure over storage time. The load test was performed according to an internal method as follows: A total of 10 packages of tortillas were stacked in a 5-gallon bucket, sealed and stored at ambient temperature (75° F.) for 28 and 52 days. Tortilla packages were removed from the bucket one by one, opened and individual tortillas were separated by hand to determine the level of sticking. Sticking is evaluated on 4 levels (FIG. 1-4). Loose=tortillas are easily separated, no sticking to each other. Zippered=tortillas make a “zipper” sound when separated but no damage occurs to the tortillas. Peeled=tortillas stick to each other when separated, the top layers stick to each other and separate from the outside layer. Torn=tortillas stick and tear completely through the tortilla.

Results

The initial results of the physical tests are shown in Table 5. For moisture, pH and water activity all samples were within the expected ranges and there were no significant differences between samples (p>0.05). The positive control had the largest diameter, while all samples had a similar weight. A sensory score above 5 indicates acceptable samples. The positive control and the lecithin/lysolecithin sample had the highest acceptability. This set of testing demonstrated that the treatment with the composition of the present invention didn't impact the physical properties of the tortilla.

TABLE 11
Initial parameters for clean label flour tortillas

| | | | | Sensory - |
|---|---|---|---|---|
| Treatment | Moisture | pH | Aw | Acceptability |
| Negative control | 29.40 | 5.46 | 0.9326 | 7.2 |
| Positive control | 30.70 | 5.42 | 0.9387 | 8.0 |
| Lecithin/lysolecithin | 31.40 | 5.46 | 0.9370 | 7.8 |
| Lecithin | 30.95 | 5.50 | 0.9374 | 7.2 |

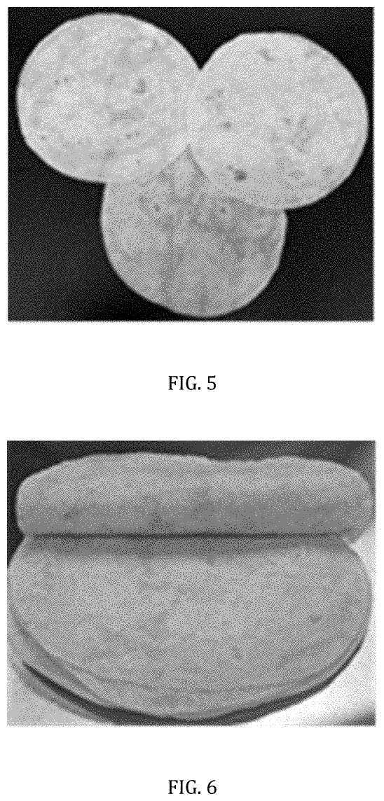

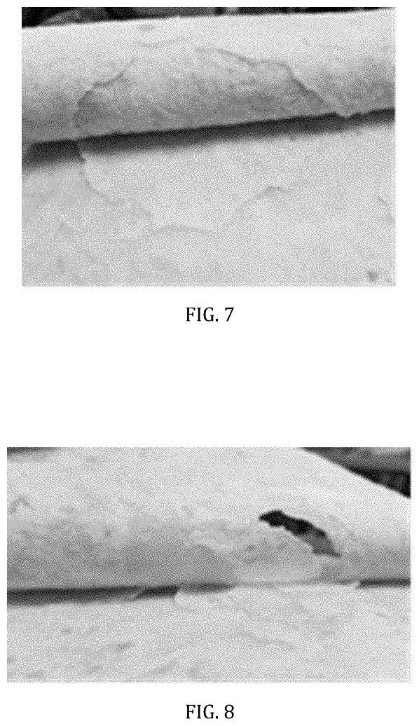

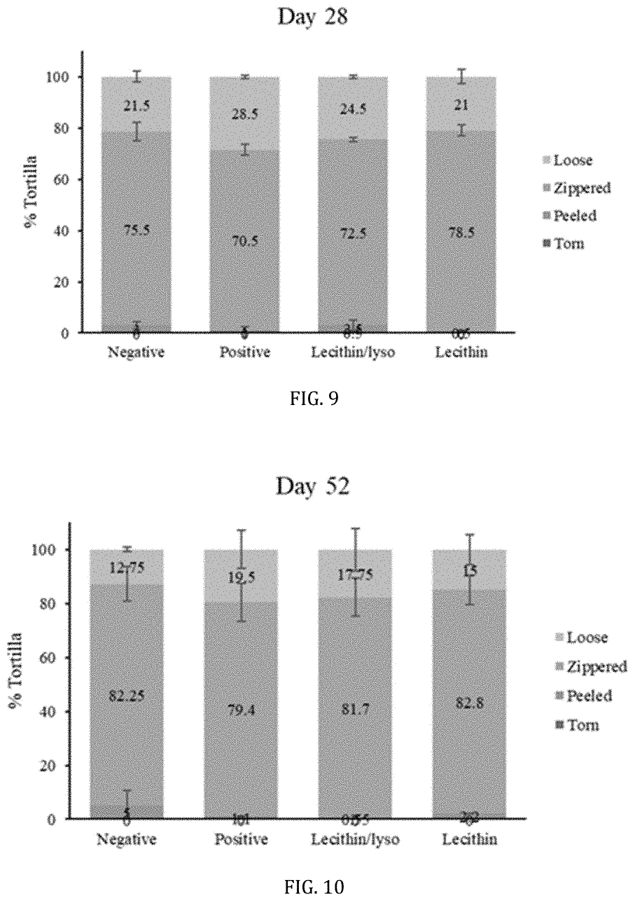

The results of the load test at day 28 and day 52 are shown in FIGS. 5 and 6. The higher the percent of loose tortillas and lower percent of peel/torn correlate to less sticking and a more effective antistick treatment. There was a progression of tortilla becoming stickier for all the groups from day 28 to day 52, which was expected. For both dates, the positive control had the greatest percentage of loose tortillas, closely followed by the group with the composition containing the lecithin and lysolecithin blend. Notably, lecithin alone was not able to provide similar anti-stickiness performance comparing to the blends, confirming that lysolecithin plays a significant role for anti-stickiness property. If the sum of loose and zippered tortilla (representing less sticky tortilla), and the sum of peeled and torn (representing more sticky tortilla) were compared among the treatment groups at the two time points, positive control and lecithin/lysolecithin have almost the same numerical values while lecithin treatment group and negative control have statistically the same values. However, lecithin still has benefit over the untreated as it resulted in less torn tortilla comparing to negative control on day 52.

In one aspect, the present invention includes a composition comprising hydrolyzed lecithin and lecithin in an amount capable of conferring an anti-stickiness characteristic to a tortilla that is comparable or superior to tortillas that use lecithin alone as an anti-stickiness agent. According to at least one embodiment, the composition contains hydrolyzed lecithin in an amount ranging from about 50 to 99.9% of the composition by weight percentage, and more preferably from about 50 to 99% of the composition by weight percentage, and lecithin in an amount ranging from about 0.1 to 25% of the composition by weight percentage, and more preferably from about 1 to 25% of the composition by weight percentage.

According to at least one embodiment, the composition is a dry ingredient. In an alternative embodiment, the composition is a wet ingredient. The composition can be incorporated into the tortilla dough by mixing the composition into the dry blend or by pre-treating the shortening (fat) with the composition during the production of tortillas. In alternative embodiments, the composition can be applied to the final tortilla.

Other aspects of the present invention relate to methods of making tortillas that will not tear or peel when separated comprising incorporating a composition comprising a blend of hydrolyzed lecithin and lecithin in an amount effective to confer anti-stickiness characteristics to the tortilla that are comparable or superior to tortillas that use lecithin alone as an anti-stickiness agent. In another embodiment the tortillas will not tear or peel when separated comprising incorporating a composition comprising a blend of hydrolyzed lecithin and lecithin in an amount effective to confer anti-stickiness characteristics to the tortilla that are comparable or superior to tortillas that use MDGs as an anti-stickiness agent.

In an at least one embodiment, the composition is a blend of hydrolyzed lecithin and lecithin that is incorporated as an ingredient during the manufacturing process, where the blend includes hydrolyzed lecithin and lecithin in amounts effective to confer superior properties, such as anti-stickiness, to the tortilla. More specifically, the composition is incorporated into the tortilla making process by incorporating into the dry pack or by pre-treating the shortening or fat that is used in making the tortilla dough.

Another aspect of the present invention relates to methods for reducing peeling or tearing of tortillas during separation from packaging comprising incorporating a composition containing hydrolyzed lecithin and lecithin in an amount effective to confer anti-stickiness properties to the tortillas.

As disclosed herein, the researchers surprisingly found that the composition with a blend of lecithin and lysolecithin was able to perform in different tortilla types that represent a commodity. This confirms the availability of wide application ranges.

It is to be understood that variations and modifications can be made on the aforementioned description without departing from the concepts of the present disclosure, and further it is to be understood that such concepts are intended to be covered by the following claims unless these claims by their language expressly state otherwise.

The foregoing descriptions and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A composition comprising hydrolyzed lecithin and lecithin in an amount capable of conferring an anti-stickiness characteristic to a tortilla that is comparable or superior to tortillas that use lecithin alone as an anti-stickiness agent.

2. The composition of claim 1 wherein the hydrolyzed lecithin is present in an amount ranging from about 50 to 99.9 percentage by weight and lecithin is present in an amount ranging from about 0.1 to 25 percentage by weight.

3. The composition of claim 1 wherein the hydrolyzed lecithin is present in an amount ranging from about 50 to 99 percentage by weight and lecithin is present in an amount ranging from about 1 to 25 percentage by weight.

4. The composition of claim 1 wherein the composition is an ingredient in the production of tortillas and includes a blend of hydrolyzed lecithin in an amount ranging from about 50 to 99.9 percentage by weight and lecithin in an amount ranging from about 0.1 to 25 percentage by weight.

5. The composition of claim 1 wherein the composition is a dry ingredient.

6. The composition of claim 1 wherein the composition is a wet ingredient.

7. The composition of claim 1 wherein the composition is incorporated into the tortillas by mixing the composition into the dry blend or by pre-treating the shortening or fat with the composition during the production of tortillas.

8. A method of making tortillas that will not tear when separated comprising incorporating a composition comprising hydrolyzed lecithin and lecithin in an amount effective to confer anti-stickiness characteristics to the tortilla that are comparable or superior to tortillas that use lecithin alone as an anti-stickiness agent.

9. The method of claim 8 wherein the composition contains hydrolyzed lecithin in an amount ranging from about 50 to 99.9 percentage by weight and lecithin in an amount ranging from about 0.1 to 25 percentage by weight.

10. The method of claim 8 wherein the composition contains hydrolyzed lecithin in an amount ranging from about 50 to 99 percentage by weight and lecithin in an amount ranging from about 1 to 25 percentage by weight.

11. The method of claim 8 wherein the composition is incorporated into the tortilla dry blend or applied to the fat.

12. The method of claim 8 wherein the composition is a dry ingredient.

13. The method of claim 8 wherein the composition is a wet ingredient.

14. The method of claim 8 where the composition is incorporated as an ingredient during the manufacturing process.

15. A method for reducing peeling or tearing of tortillas during separation from packaging comprising incorporating a composition containing hydrolyzed lecithin and lecithin in an amount effective to confer anti-stickiness properties to the tortillas.

16. The method of claim 15 wherein the composition contains hydrolyzed lecithin in an amount ranging from about 50 to 99.9 percentage by weight and lecithin in an amount ranging from about 0.1 to 25 percentage by weight.

17. The method of claim 15 wherein the composition is incorporated into the tortilla dry blend or applied to the fat.

18. The method of claim 15 wherein the composition is a dry ingredient.

19. The method of claim 15 wherein the composition is a wet ingredient.

20. The method of claim 14 where the composition is incorporated as an ingredient during the manufacturing process.
